(19) United States
(12) Patent Application Publication
(10) Pub. No.: US 2010/0290056 A1
(43) Pub. Date: Nov. 18, 2010

(54) Abnormality detection appraratus of optical fiber gyro

(76) Inventors: Hisayoshi Sugihara, Aichi-ken (JP); Yutaka Nonomura, Aichi-ken (JP); Motohiro Fujiyoshi, Aichi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/989,866

(22) PCT Filed: Aug. 1, 2006
(86) PCT No.: PCT/IB2006/002096

§ 371 Date: Aug. 4, 2010

(30) Foreign Application Priority Data
Aug. 1, 2005 (JP) 2005-223506

(51) Int. Cl. G01C 19/72

(52) U.S. Cl. 356/460

(57) ABSTRACT

The numbers of pulses of the CW signal and the CCW signal of the optical fiber gyro during a predetermined sampling duration are detected by samplers. An abnormality determiner determines that the optical fiber gyro is normal if at least one of the pulse numbers is greater than or equal to a threshold value. If both pulse numbers are smaller than the threshold value, the abnormality determiner determines that an abnormality, such as a circuit break, a bad connection, etc., has occurred, and outputs the result of determination to an output unit. The abnormality determiner may determine an abnormality on the basis of the presence/absence of quantization noise.

### BACKGROUND OF THE INVENTION

1. Field of the Invention

The invention relates to an apparatus that detects an abnormality of an optical fiber gyro.

2. Description of the Related Art

Acceleration sensors and angular velocity sensors are used to control attitude of a movable body such as a robot. Three axes of the robot that are orthogonal to each other are referred to as an X-axis, a Y-axis, and a Z-axis. Accelerations that act in the direction in which the X-axis, the Y-axis, and the Z-axis extend are detected by the respective three acceleration sensors. The angular velocities about the X-axis, the Y-axis, and the Z-axis are detected by respective three angular velocity sensors. The angles about the axes, or the attitude angles, are obtained by temporally integrating outputs from the angular velocity rate sensors, and the roll angle, the pitch angle, and the yaw angle are calculated.

Japanese Patent Application Publication No. 2004-268730 describes a technology for performing attitude control using the data concerning acceleration and the data concerning attitude that are transmitted from a gyro sensor.

However, since the attitude angle is found by temporally integrating an angular velocity, the offset and the drift of the angular velocity sensor are gradually accumulated. Therefore, if the offset and like are large, they gradually form a very large value, which increases and diverges with time. If an optical fiber gyro is used, high-accuracy angular velocity detection with a reduced amount of drift can be achieved. However, since the optical fiber gyro employs an optical circuit, it is hard to extract internal signals, which gives rise to a problem of difficult detection of abnormality.

### SUMMARY OF THE INVENTION

The invention provides an apparatus capable of easily detecting abnormality in an optical fiber gyro.

A first aspect of the invention comprises: a sampler that samples pulses which are contained respectively in a clockwise signal and a counterclockwise signal of an optical fiber gyro, and whose periods are in accordance with an angular velocity in a clockwise direction and an angular velocity in a counterclockwise direction, during a predetermined time, and that counts a pulse number of each signal; and an abnormality determiner that determines an abnormality of the optical fiber gyro based on whether or not each of the pulse number of the clockwise signal and the pulse number of the counterclockwise signal is smaller than a predetermined threshold value.

The optical fiber gyro outputs pulses whose period is in accordance with an angular velocity. Utilizing the fact that pulses that are to be normally output are not output if an abnormality, such as a circuit break or the like, occurs in the optical fiber gyro, the first aspect of the invention easily and reliably determines abnormality of the optical fiber gyro through magnitude comparison of the pulse numbers with a predetermined threshold value. When the mobile body is rotating clockwise (CW), pulses are generated in a clockwise signal. When the mobile body is rotating counterclockwise (CCW), pulses are generated in a counterclockwise signal. If the pulse number of either signal is greater than or equal to a predetermined threshold value, it can be determined that the optical fiber gyro is normally operating. If the pulse number of each signal is smaller than the predetermined value, it can be determined that an abnormality of some sort has occurred in the optical fiber gyro. The first aspect of the invention utilises the existing pulse number counting circuit for detecting the angular velocity without any substantial modification to the circuit, and accomplishes abnormality detection by using results of the counting of the pulse number counting circuit.

Furthermore, a second aspect of the invention comprises: a detector that detects quantization noise of pulses which are contained respectively in a clockwise signal and a counterclockwise signal of an optical fiber gyro, and whose periods are in accordance with an angular velocity in a clockwise direction and an angular velocity in a counterclockwise direction; and an abnormality determiner that determines an abnormality of the optical fiber gyro based on presence/absence of the quantization noise.

In the second aspect of invention, pulses in accordance with an angular velocity are output from an optical fiber. Therefore, when the mobile body is not rotating but at standstill, pulses are not output, that is, the pulse number is not available for determining normality/abnormality of the optical fiber gyro. However, the optical fiber gyro generates a pulse output from a light phase difference caused by a rotation-associated optical path difference based on the Sagnac effect. When the phase difference is converted into a pulse output, quantization noise always occurs in association with wobble of light, or the like. Therefore, by detecting this quantization noise, an abnormality of the optical fiber gyro can be detected even when the mobile body is at standstill.

According to the aspects of the invention, an abnormality of an optical fiber gyro can easily be detected.

### BRIEF DESCRIPTION OF THE DRAWINGS

The foregoing and further objects, features and advantages of the invention will become apparent from the following description of an example embodiment with reference to the accompanying drawings, wherein the same or corresponding portions will be denoted by the same reference numerals and wherein:

FIG. 1 is a construction block diagram of a first embodiment;

FIG. 2 is a construction block diagram of a second embodiment; and

FIG. 3 is a construction block diagram of a third embodiment.

### DETAILED DESCRIPTION OF THE EXAMPLE EMBODIMENT

Embodiments of the invention will be described hereinafter with reference to the drawings.

### First Embodiment

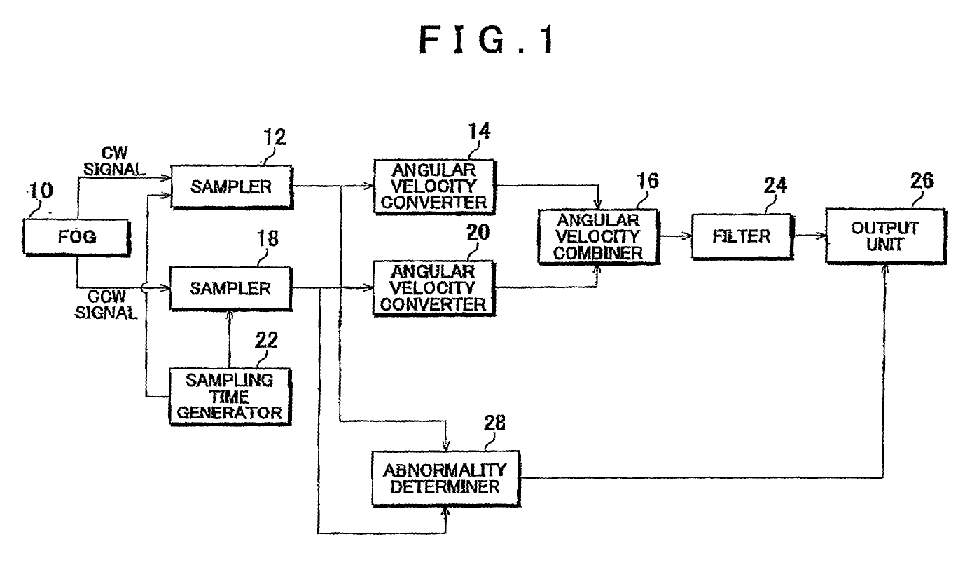

FIG. 1 shows a construction block diagram of the first embodiment. An optical fiber gyro (FOG) 10 is provided at a predetermined position in a mobile body such as a robot or the like.

The optical fiber gyro 10 outputs a CW signal which is a clockwise signal, and a CCW signal which is a counterclockwise signal. The optical fiber gyro 10 will be briefly described below. In the optical fiber gyro 10, an optical fiber is revolved around a bobbin, and laser light from a light source is caused to enter the optical fiber and travel therethrough clockwise and counterclockwise. The speed of light is constant irrespective of the motion of the optical fiber. Therefore, if the exit of the optical fiber moves, the time needed for the laser light to reach the exit changes in proportion to the rotation speed of the optical fiber. By detecting a change in the needed time, the rotation speed of the optical fiber, that is, the angular velocity of the mobile body, is detected. When the mobile body rotates clockwise, the optical fiber gyro 10 outputs a CW signal (pulse signal) whose pulses each correspond to an angle of about 4.5 seconds, for instance. When the mobile body rotates counterclockwise, the optical fiber gyro 10 outputs a CCW signal (pulse signal) whose pulses each correspond to an angle of about 4.5 seconds, for instance. If the angular velocity of the mobile body increases, the period of pulses shortens. Therefore, by counting the number of pulses contained in the CW signal, the rotation angle during that time, that is, the clockwise angular velocity, is obtained. Likewise, by counting the number of pulses contained in the CCW signal, the counterclockwise angular velocity is obtained. The net angular velocity of the mobile body is obtained by a difference between the angular velocity in the CW direction and the angular velocity in the CCW direction. The optical fiber gyro 10 outputs the CW signal and the CCW signal to samplers 12, 18.

The samplers 12, 18 sample the CW signal and the CCW signal, respectively, for a predetermined duration, and count the pulse numbers. The predetermined duration is set by a sampling time generator 22. The samplers 12, 18 output the pulse numbers to angular velocity converters 14, 20, respectively. The samplers 12, 18 also output the pulse numbers to an abnormality determiner 28.

The angular velocity converters 14, 20 convert the pulse numbers input from the samplers 12, 18, that is, the numbers of pulses during the predetermined duration, into an angular velocity in the CW direction and an angular velocity in the CCW direction, respectively, by multiplying the pulse numbers by a predetermined coefficient. For example, if 1000 pulses are sampled during a sampling duration of 100 ms, then 4.5 (second in angle/pulse)*1000 (pulse)/0.1 (S)=45000 (second in angle/s)=12.5 (deg/s) is obtained as an angular velocity. The angular velocity converters 14, 20 output the angular velocities obtained through computation to an angular velocity combiner 16.

The angular velocity combiner 16 combines the angular velocity in the CW direction and the angular velocity in the CCW direction (computes a difference therebetween), thus detecting the angular velocity. The angular velocity combiner 16 outputs the angular velocity obtained through computation to a filter 24.

The filter (low-pass filter) 24 removes noise contained in the angular velocity input from the angular velocity combiner 16, and outputs the noise-removed angular velocity to an output unit 26.

The output unit 26, in accordance with a command from a main processor (host processor) that controls the attitude of the robot, transmits the detected angular velocity, or an attitude angle obtained by integration of the angular velocity, to the main processor.

In the meantime, the numbers of pulses during the predetermined sampling duration are also output to the abnormality determiner 28 as mentioned above. The abnormality determiner 28 compares the pulse number of the CW signal and the pulse number of the CCW signal respectively with a threshold value. If the optical fiber gyro 10 has an abnormality, such as a circuit break, an optical path cutoff, a bad connection, etc., the pulse number of the CW signal or the CCW signal becomes zero, or conspicuously small. Hence, the abnormality determiner 28 determines that the optical fiber gyro 10 is normal if at least one of the pulse number of the CW signal and the pulse number of the CCW signal is greater than or equal to the threshold value. If both the pulse number of the CW signal and the pulse number of the CCW signal are smaller than the threshold value, the abnormality determiner 28 determines that the optical fiber gyro 10 is abnormal, and outputs the result of determination to the output unit 26. Thus, the abnormality determiner 28 determines the presence/absence of an abnormality by using the numbers of pulses detected during the predetermined sampling duration. However, the CW signal and the CCW signal are contaminated with random quantization noise in association with the pulse conversion. The quantization noise is normally unnecessary for signal processing and is therefore removed. If there is an abnormality, such as a circuit break or the like, the quantization noise becomes absent as well. Hence, the presence/absence of quantization noise in the CW signal and the CCW signal may be detected for abnormality determination. The abnormality determination based on the presence/absence of quantization noise may be used in combination with or subsidiarity to the abnormality determination based on the magnitude comparison of the pulse numbers with the threshold value. For example, during rotation or travel of the mobile body, the abnormal determination is performed on the basis of the magnitude comparison of the pulse numbers with the threshold value. When the mobile body is at standstill, the abnormal determination is switched to the determination based on the presence/absence of quantization noise. When the mobile body is at standstill, pulses do not occur in the CW signal or the CCW signal; however, the detection of the presence/absence of quantization noise as described above makes it possible to detect an abnormality, regardless of whether the mobile body is moving or at standstill. Although quantization noise is contained in both the CW signal and the CCW signal, a sufficiently long sampling duration provides substantially equal numbers of pulses of quantization noise in the two signals, so that the noise pulse numbers cancel each other in the computation of the difference between the CW signal and the CCW signal. Therefore, by monitoring the CW signal pulse number and the CCW signal pulse number after the samplers 12, 18, an abnormality of the optical fiber gyro can be detected.

A concrete example of an algorithm of abnormal determination will be described below. First, the sampling duration is set at a predetermined duration, and the threshold value is set at a sufficiently small value. Then, the pulse numbers of the CW signal and the CCW signal are compared with the threshold value. If at least one of the pulse numbers is greater than or equal to the threshold value, it is determined that the optical fiber gyro 10 is normal. However, if the pulse numbers of the two signals are both smaller than the threshold value, it is subsequently determined whether or not quantization noise is present. If the pulse numbers are smaller than the threshold value but quantization noise exists, it is determined that the optical fiber gyro 10 is normal without any circuit break or the like. If the pulse numbers are smaller than the threshold value and quantization noise does not exist, it is determined that the optical fiber gyro 10 is abnormal.

In this embodiment, while the optical circuit of the optical fiber gyro 10 is maintained as it is in the existing technology, abnormality of the optical fiber gyro 10 can easily be detected. Thus, it is possible to improve the reliability of an angular velocity detection system, an attitude angle detection system, and a posture control system that employ the optical fiber gyro 10.

### Second Embodiment

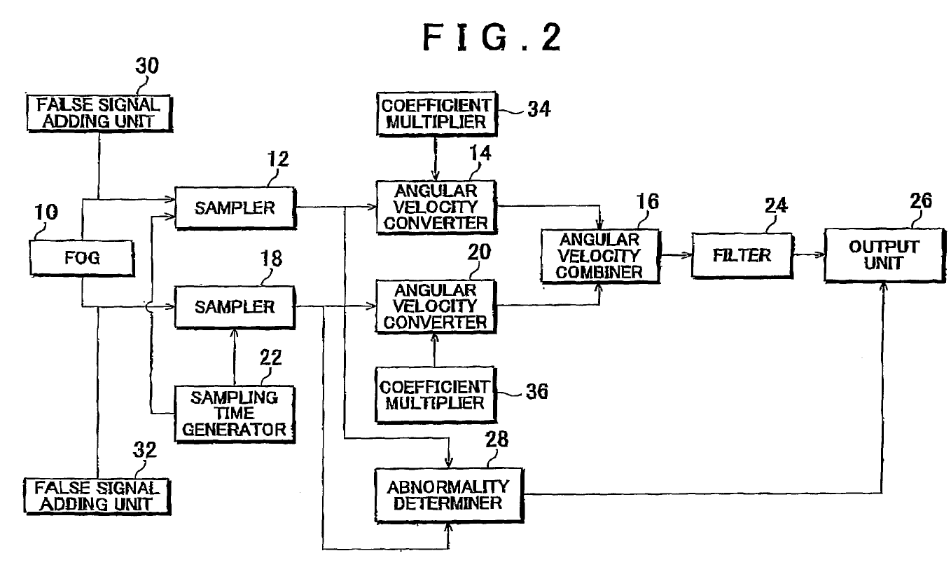

FIG. 2 shows a construction block diagram of the second embodiment. The construction shown in FIG. 2 is different from the construction shown in FIG. 1 in that false signal adding units 30, 32 for adding false signals to the CW signal and the CCW signal, respectively, are provided, and in that coefficient multipliers 34, 36 for supplying coefficients for computing angular velocities to angular velocity converters 14, 20, respectively, are provided.

The false signal adding units 30, 32 generate low-frequency pulse signals as false pulse signals, and add them to the CW signal and the CCW signal, respectively. Since samplers 12, 22 count the numbers of pulses during a predetermined sampling duration, the samplers 12, 22 detect the numbers of false pulses as well as the pulses of the original CW and CCW signals, and output the counted pulse numbers to an abnormality determiner 28. The abnormality determiner 28 determines whether or not false pulses whose period is known have been detected. If a false pulse signal does not exist, the abnormality determiner 28 determines that an abnormality, such as a circuit break, a bad connection, etc., has occurred. Since false pulses are superposed at the same frequency on the CW signal and the CCW signal, the false pulses are detectable by the abnormality determiner 28, but do not affect the output due to the computation of the difference performed by an angular velocity combiner 16. The false pulse signals can be adjusted in period and pulse number independently as far as the pulse numbers can be considered equal in the CW and CCW signals during the sampling duration.

The coefficient multipliers 34, 36 supply the angular velocity converters 14, 20 with coefficients (conversion coefficients) for calculating angular velocities from the pulse numbers of the CW signal and the CCW signal, respectively. By independently setting the coefficients of the coefficient multipliers 34, 36, the sensitivity difference between the CW and CCW signals can be adjusted.

### Third Embodiment

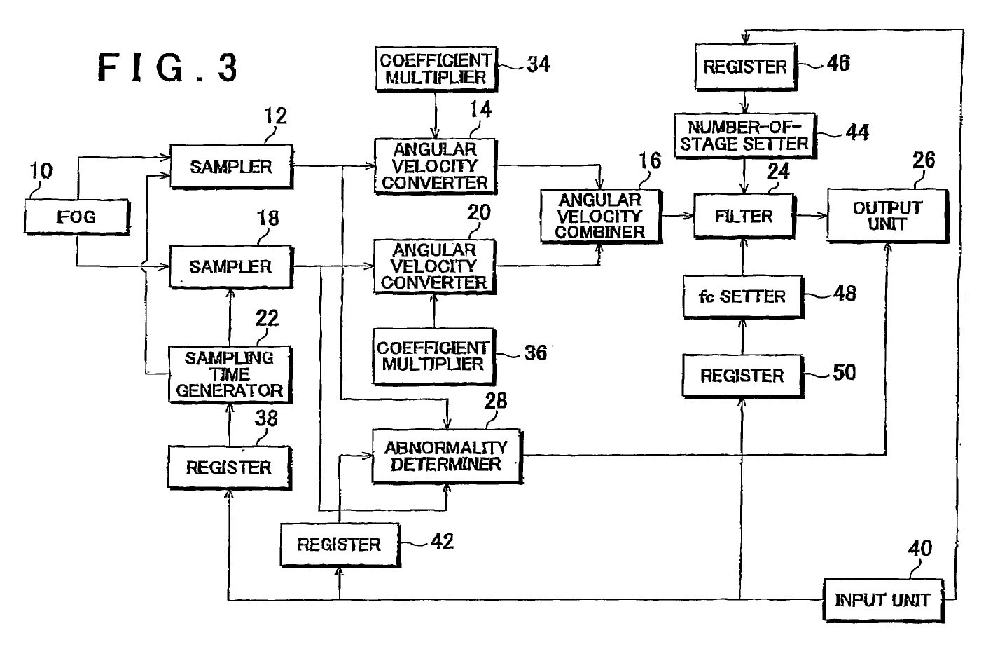

FIG. 3 shows a construction block diagram of the third embodiment. The construction shown in FIG. 3 is different from the construction shown in FIG. 1 in that a register 38 that sets a predetermined sampling duration for a sampling time generator 22, a register 42 that sets a determination threshold value for an abnormality determiner 28, and coefficient multipliers 34, 36 that set conversion coefficients for angular velocity converters 14, 20 are provided, and in that an input unit 40 with which a user can set the aforementioned values at desired values is provided. By variably setting the sampling duration via the input unit 40 and the register 38, the sampling duration can be appropriately set in conformity with the movement characteristic of the mobile body, and therefore responsiveness suitable for the mobile body can be realized. That is, the sampling duration is set relatively long for a mobile body that moves at low speed, since the period of pulses for that mobile body becomes long. The sampling duration is set relatively short for a mobile body that moves at high speed, since the period of pulses for that mobile body becomes short. The abnormal determination can also be executed in conformity with the movement characteristic of the mobile body by adjusting the threshold value used by the abnormality determiner 28 through the use of the input unit 40 and the register 42. Specifically, examples of such adjustment include reducing the threshold value for a mobile body that moves at low speed, and increasing the threshold value for a mobile body that moves at high speed, etc.

The construction shown in FIG. 3 is further provided with an fc (cut-off frequency) setter 48 and a register 50 for variably setting a cut-off frequency fc of a filter (low-pass filter) 24 that removes noise contained in the angular velocity input from the angular velocity combiner 16, and a number-of-stage (tap number) setter 44 and a register 46 for variably setting an attenuation factor. The fc and the number of stages are set by the registers 50, 46, and the values of the registers 50, 46 can be set at desired values by a user through the use of the input unit 40. Therefore, the dynamic handling of the responsiveness and band becomes possible.

1. An abnormality detection apparatus of an optical fiber gyro, by comprising:
a sampler that samples pulses which are contained respectively in a clockwise signal and a counterclockwise signal of an optical fiber gyro, and whose periods are in accordance with an angular velocity in a clockwise direction and an angular velocity in a counterclockwise direction, during a predetermined time, and that counts a pulse number of each signal;
a false pulse signal adding unit that adds a false pulse signal of a predetermined period to at least one of the clockwise signal and the counterclockwise signal, wherein the added false pulse signal is detectable independently from the at least one of the clockwise signal and the counterclockwise signal; and
an abnormality determiner that determines an abnormality of the optical fiber gyro if each of the pulse number of the clockwise signal and the pulse number of the counterclockwise signal is smaller than a predetermined threshold value and the false pulse signal does not exist.

2. An abnormality detection apparatus of an optical fiber gyro, by comprising:
a detector that detects quantization noise of pulses which are contained respectively in a clockwise signal and a counterclockwise signal of an optical fiber gyro, and whose periods are in accordance with an angular velocity in a clockwise direction and an angular velocity in a counterclockwise direction;
a false pulse signal adding unit that adds a false pulse signal of a predetermined period to at least one of the clockwise signal and the counterclockwise signal, wherein the added false pulse signal is detectable independently from the at least one of the clockwise signal and the counterclockwise signal; and
an abnormality determiner that determines an abnormality of the optical fiber gyro if one of the quantization noise and the false pulse signal does not exist.

3. An abnormality detection apparatus of an optical fiber gyro, comprising:
a sampler that samples pulses which are contained respectively in a clockwise signal and a counterclockwise signal of an optical fiber gyro, and whose periods are in accordance with an angular velocity in a clockwise direction and an angular velocity in a counterclockwise direction, during a predetermined time, and that counts a pulse number of each signal;
a detector that detects quantization noise of pulses which are contained respectively in the clockwise signal and the counterclockwise signal of the optical fiber gyro, and whose periods are in accordance with the angular velocity in the clockwise direction and the angular velocity in the counterclockwise direction;
a false pulse signal adding unit that adds a false pulse signal of a predetermined period to at least one of the clockwise signal and the counterclockwise signal, wherein the added false pulse signal is detectable independently from the at least one of the clockwise signal and the counterclockwise signal; and
an abnormality determiner that determines an abnormality of the optical fiber gyro if each of the pulse number of the clockwise signal and the pulse number of the counterclockwise signal is smaller than a predetermined threshold value and the quantization noise does not exist and the false pulse signal do not exist.

4. (canceled)

5. The abnormality detection apparatus of the optical fiber gyro according to claim 1, further comprising a setting unit that variably sets the predetermined time.

6. The abnormality detection apparatus of the optical fiber gyro according to claim 3, further comprising a setting unit that variably sets the predetermined time.
